(19) United States
(12) Patent Application Publication
(10) Pub. No.: US 2008/0026835 A1
(43) Pub. Date: Jan. 31, 2008

(54) GAME SYSTEM, GAMING MACHINE, A METHOD FOR PROVIDING GAME THAT PROVIDES A PLURALITY OF BONUS POOLS

(75) Inventor: Kazumasa YOSHIZAWA, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Aruze Corp., Koto-ku (JP)

(21) Appl. No.: 11/779,449

(22) Filed: Jul. 18, 2007

(30) Foreign Application Priority Data
Jul. 26, 2006 (JP) 2006-203493

(51) Int. Cl. G06F 17/00

(52) U.S. Cl. 463/27

(57) ABSTRACT

A game system includes: a plurality of gaming machines that is provided for each of players, each of the gaming machines receiving a bet from respective one of the players; a display; and a controller that is connected to the gaming machines and operates to: store a part of the bet in a plurality of bonus pools when the bet is received; control the display to display images corresponding to the bonus pool amounts stored in the bonus pools; and pay out a bonus pool amount that is stored in one of the bonus pools when a predetermined condition is satisfied.

### CROSS-REFERENCE TO THE RELATED APPLICATION(S)

The present application is based upon and claims priority from prior Japanese Patent Application No. 2006-203493, filed on Jul. 26, 2006, the entire content of which are incorporated herein by reference.

### TECHNICAL FIELD

The present invention relates to a game system, a gaming machine, and a gaming method that provides a game implemented with a so-called progressive bonus in which a part of value of game media being bet through the gaming machine is accumulatively stored, and when a predetermined condition is satisfied, a part or the whole of the accumulatively stored game media. The present invention also relates to a game system, a gaming machine, and a gaming method that provides a game displaying images corresponding to bonus pool amounts accumulated in each of the bonus pools.

### BACKGROUND

When playing gaming machines of a type that uses medals as game media, such as a slot machine, a roulette machine, a bingo machine, and a horse race gaming machine, a player starts a game by purchasing or borrowing a plurality of medals from a medal lending machine and inserting the medals into the gaming machine. When the player wins the game, a predetermined number of medals are paid out. Accordingly, a player who has acquired a plurality of medals can enjoy the game continuously without newly purchasing or borrowing the medals.

Recently, among the gaming machines, gaming machines that provide a game implemented with a progressive bonus for drawing the interest of the player are prevailed. The progressive bonus is paid out by accumulating medals corresponding to a predetermined ratio of the number of medals betted by a player each game into a jackpot and paying the medals corresponding to the number of accumulated medals at once in a case where a predetermined condition is satisfied. Accordingly, the player can acquire an award having a high value that is hardly be acquired in a game without such progressive bonus.

Here, in the gaming machines that provides a game implemented with the progressive bonuses, the accumulation amount currently accumulated in a jackpot is indicated. For example, In JP-A-2004-267428, there is disclosed a gaming system that adds a value resulting from multiplying an amount of inserted medals by a predetermined rate to an accumulation amount accumulated in a jackpot and has a display unit indicating the current accumulation amount to a player.

However, in the configuration disclosed in JP-A-2004-267428, since the accumulation amount of medals in the jackpot is directly indicated by a specific number, detailed information on the accumulation amount, however, effects in terms of representation are insufficient. Here, the current accumulation amount of medals accumulated in the jackpot is to be frequently checked by the player on the basis of expectation for wining.

### SUMMARY

One of objects of the present invention is to provide a game system, a gaming machine, and a gaming method that improve entertaining features by enhancing the representation for indicating the accumulation amount accumulated in the jackpot.

According to a first aspect of the invention, there is provided a game system including: a plurality of gaming machines that is provided for each of players, each of the gaming machines receiving a bet from respective one of the players; a display; and a controller that is connected to the gaming machines and operates to: store a part of the bet in a plurality of bonus pools when the bet is received; control the display to display images corresponding to the bonus pool amounts stored in the bonus pools; and pay out a bonus pool amount that is stored in one of the bonus pools when a predetermined condition is satisfied.

According to a second aspect of the invention, there is provided a gaming machine including: an operation unit that receives a bet from a player; a display; and a processor that operates to: store a part of the bet in a plurality of bonus pools when the bet is received; control the display to display images corresponding to the bonus pool amounts stored in the bonus pools; and pay out a bonus pool amount that is stored in one of the bonus pools when a predetermined condition is satisfied.

According to a third aspect of the invention, there is provided a method for providing a game to a player, the method including: receiving a bet from the player; storing a part of the bet in a plurality of bonus pools when the bet is received; displaying images corresponding to the bonus pool amounts stored in the bonus pools; and paying out a bonus pool amount that is stored in one of the bonus pools when a predetermined condition is satisfied.

### BRIEF DESCRIPTION OF THE DRAWINGS

In the accompanying drawings:

FIG. 1 is a diagram showing a jackpot amount display screen displayed on a main display of a game system according to a first embodiment of the present invention;

FIG. 2 is a schematic diagram showing a game system according to the first embodiment;

FIG. 3 is a perspective view of a slot machine showing an external view thereof according to the first embodiment;

FIG. 4 is a schematic diagram of sets of symbol series that are drawn on outer peripheries of reels;

FIG. 5 is a schematic block diagram of a control system of the slot machine according to the first embodiment;

FIG. 6 is a schematic block diagram showing a control system of a server according to first embodiment;

FIG. 7 is an award table showing winning combinations of the slot machine according to the first embodiment and corresponding winning probabilities and awards;

FIG. 8 is a diagram showing a bonus game lottery table according to the first embodiment;

FIG. 9 is a diagram showing an accumulation target lottery table of a game system according to the first embodiment;

FIG. 10 is a flowchart of a main control program in the slot machine according to the first embodiment;

FIG. 11 shows flowcharts of a program for a main game process in the slot machine according to the first embodiment and a program for a jackpot amount accumulation process in a server;

FIG. 12 shows flowcharts of a program for a bonus game process of the slot machine according to the first embodiment and a program for a bonus game jackpot updating process of the server;

FIG. 13 is a diagram showing fish images displayed on the jackpot amount display screen;

FIG. 14 is a diagram showing the jackpot amount display screen at a time when a jackpot accumulation process is performed;

FIG. 15 is a diagram showing a bonus game screen displayed in a lower image display panel of the slot machine;

FIG. 16 is a diagram showing a bonus game screen with an award displayed;

FIG. 17 is a diagram showing fish images displayed on the jackpot amount display screen;

FIG. 18 is a flowchart of a program for a main game process in a slot machine according to a third embodiment of the invention; and

FIG. 19 is a flowchart of a program for a bonus game process in a slot machine according to the third embodiment.

### DETAILED DESCRIPTION

Hereinafter, a gaming machine and a game system according to first to third embodiments of the present invention which are implemented as a game system 3 including a plurality of slot machines 1 and a server 2 will be described in detail with reference to the accompanying drawings.

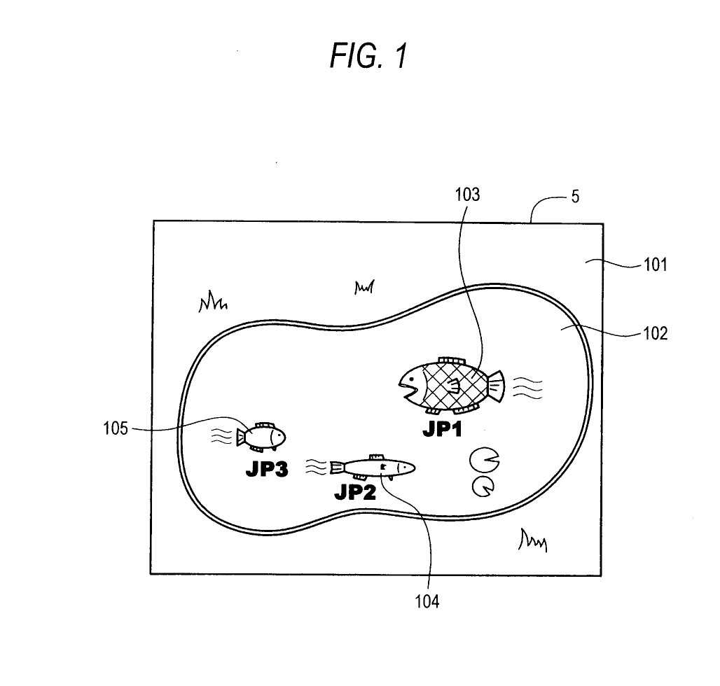

The game system 3 and the slot machine 1 according to embodiments of the present invention have three types of jackpots that store parts of betted game media, and, as shown in FIG. 1, accumulation amounts currently accumulated in the jackpots are configured to be indicated by types of images of three fishes including a first fish 103 to a third fish 105 that swim in a jackpot amount display screen 101 displayed on a main display 5.

### First Embodiment

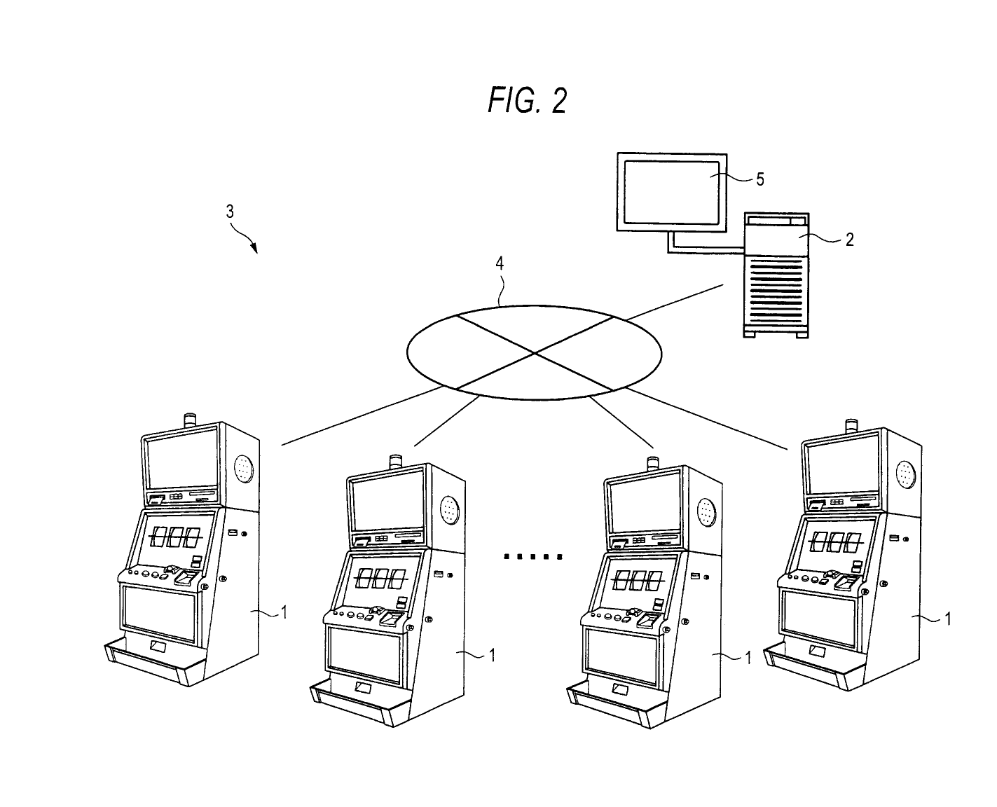

At first, a schematic configuration of the game system 3 according to the first embodiment will be described. FIG. 2 is a schematic diagram of the game system 3 according to the first embodiment.

As shown in FIG. 2, the game system 3 according to the first embodiment includes a plurality of slot machines 1 installed in a game arcade, a server 2 also installed in the game arcade, and a network 4 connecting the slot machine 1 and the server 2 to enable them to communicate with each other. A detailed configuration of the slot machine 1 will be described later.

Here, the network 4, for example, is configured by a communication line such as a LAN (Local Area Network) that can perform two way communications. The slot machine 1 and the server 2 transmit and receive various information related to the game through the network 4. For example, as described later, when a betting operation is performed using the slot machine 1, the betting information is transmitted from the slot machine 1 to the server 2. In addition, when the slot machine 1 wins a jackpot, the accumulated amount of the jackpot that is currently accumulated is transmitted from the server 2 to the slot machine 1 that has won.

The server 2 includes a main display 5, and the main display 5 is installed at a position where the images displayed thereon are visible to all of the players who play the game with the slot machines 1. The server 2 according to the first embodiment includes memory areas for storing the accumulated amounts of three types of jackpots (a first jackpot, a second jackpot, and a third jackpot) therein. Three fish images indirectly indicating the amounts accumulated from corresponding initial values in the jackpots are displayed on the main display 5 (see FIG. 1).

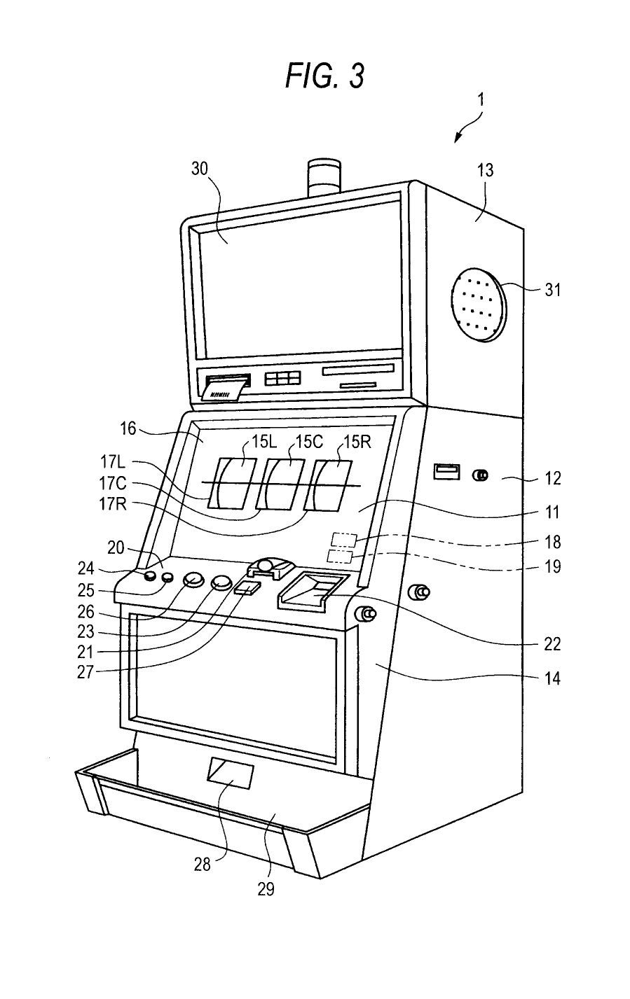

Next, the schematic configuration of a slot machine 1 according to the first embodiment will be described with reference to FIG. 3. FIG. 3 is an external perspective view of the slot machine according to the first embodiment.

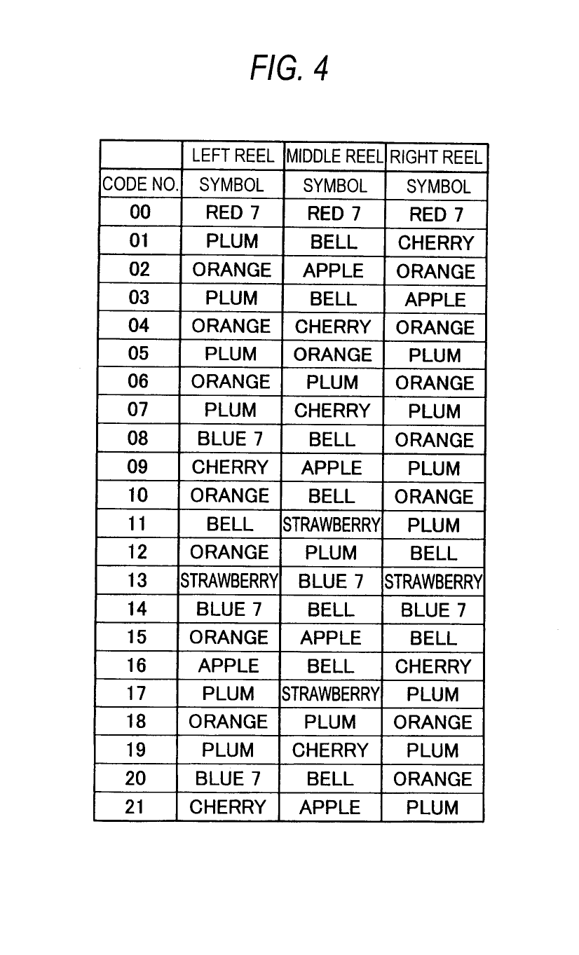

The slot machine 1 according to the first embodiment includes a cabinet 12, a top box 13 that is installed on the top side of the cabinet 12, and a main door 14 that is provided on a front face of the cabinet 12. Inside the cabinet 12, three reels 15L, 15C, and 15R are provided in a rotatable manner. On outer peripheries of the reels 15L, 15C, and 15R, symbol series (see FIG. 4) including 22 drawing patterns (hereinafter, referred to as symbols) are drawn, respectively.

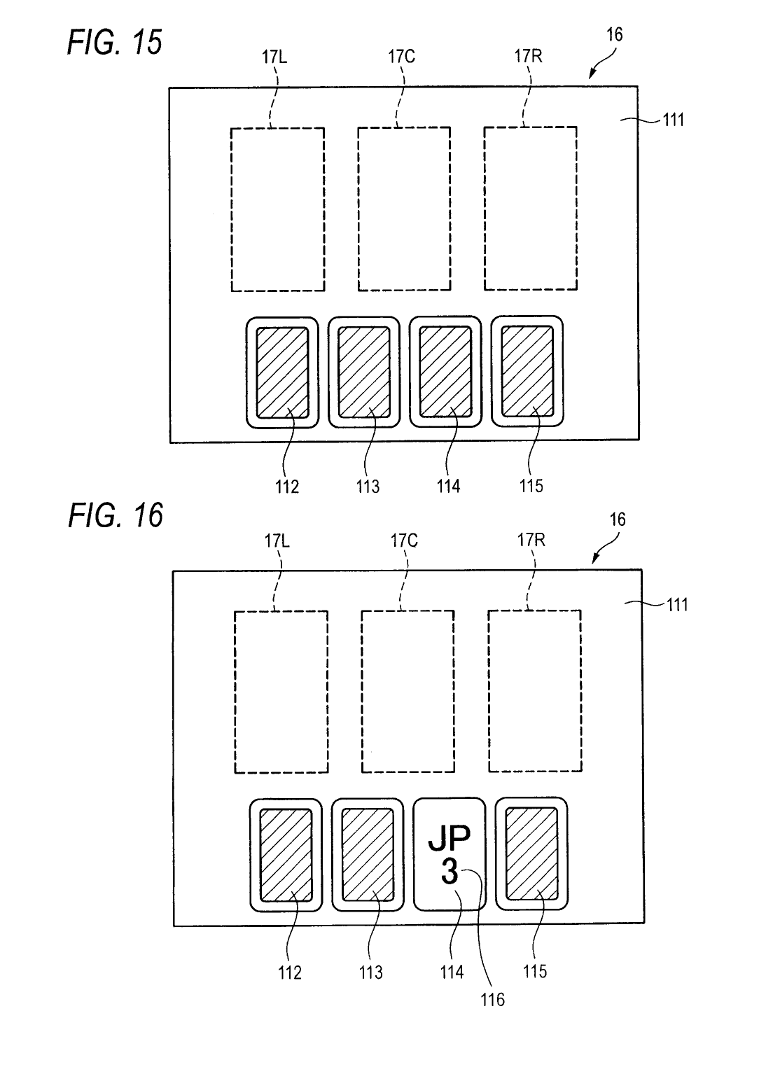

On the front sides of the reels 15L, 15C, and 15R in the main door 14, a lower image display panel 16 is provided. Here, the lower image display panel 16 is provided with a known transparent liquid crystal display panel. Display windows 17L, 17C, and 17R are configured to be in a transparent status during the play of a base game, and whereby drawing patterns drawn on the reels 15L, 15C, 15R are viewable. On the other hand, the display windows 17L, 17C, and 17R are configured to be in a non-transparent status during the play of a bonus game, so that a predetermined bonus screen (See FIGS. 15 and 16) is displayed.

In addition, on the front side of the lower image display panel 16, a touch panel 11 is provided, and a player can input various directions by operating the touch panel 11. The touch panel 11 of the slot machine 1 according to the first embodiment is used for selection of a card (see FIG. 15) that is an option displayed on the lower image display panel 16 in a bonus game to be described later.

In addition, a credit amount display portion 18 and a payout amount display portion 19 are provided on the lower image display panel 16. On the credit amount display portion 18, the number of credits that the player currently owns is displayed. On the payout amount display portion 19, the amount of an award given in a case where a combination of symbols stopped to be displayed on the pay line L is a predetermined combination or the amount of an award that is acquired in a bonus game is displayed as a payout number.

In addition, on the lower image display panel 16, three display windows 17L, 17C, and 17R of which rear faces can be recognized are formed. Through each one of the display window 17L, 17C, and 17R, three symbols drawn on outer peripheries of the reels 15L, 15C, and 15R are displayed. In addition, on the lower image display panel 16, one pay line L that horizontally traverses the three display windows 17L, 17C, and 17R is formed. The pay line L defines a combination of symbols. When the combination of symbols stopped to be displayed on the pay line L is a predetermined combination, an award depending on the combination and the number of betted credits (the number of bets) is given.

Below the image display panel 16, a control panel 20 in which a plurality of buttons for a player's inputting directions related to progress of a game are disposed, a coin insertion slot 21 for receiving coins as game media into a cabinet 12, and a bill discriminator 22 are provided.

On the control panel 20, a spin button 23, a change button 24, a CASHOUT button 25, 1-BET button 26, and a MAX-BET button 27 are provided. The spin button 23 is an operation tool for input of a direction for starting rotation of the reels 15L, 15C, and 15R. The change button 24 is an operation tool for requesting a clerk of a game arcade for money exchange. The CASHOUT button 25 is an operation tool for input of a direction for paying out coins (one credit corresponds to one coin) corresponding to the number of credits that the player owns from a coin payment slot 28 to a coin tray 29 or a direction for payment on the basis of a ticket having a bar code.

The 1-BET button 26 is an operation tool for receiving a direction for putting (betting) one credit among credits that the player owns on a game. The MAX-BET button 27 is an operation tool for receiving a direction for putting the maximum credits (50 credits in the first embodiment), that can be betted in one game, among credits that the player owns on a game.

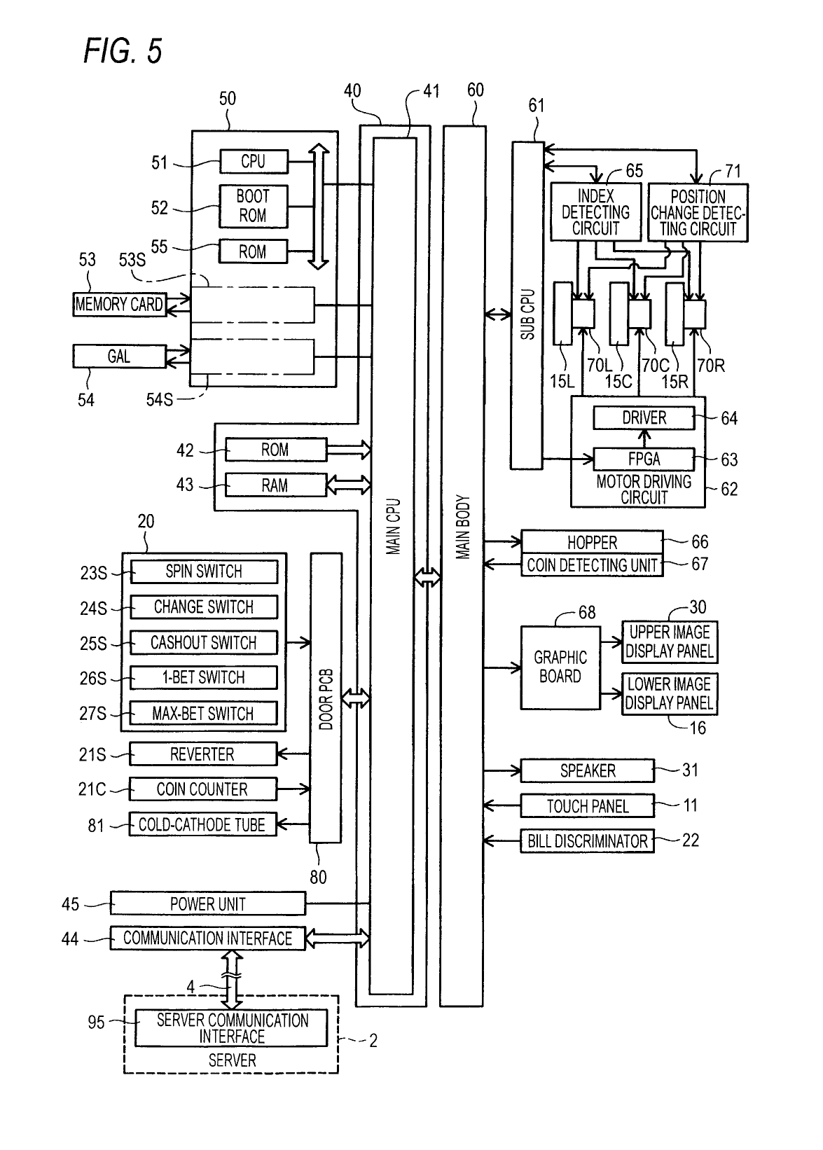

Inside the coin insertion slot 21, a reverter 21S and a coin counter 21C (see FIG. 5) are provided. The reverter 21S checks validity of coins inserted into the coin insertion slot 21 and discharges coins other than acceptable coins through the coin payment slot 28. In addition, the coin counter 21C detects inserted acceptable coins and counts the number of the inserted acceptable coins.

The bill discriminator 22 checks the validity of bills and inserts acceptable bills inside the cabinet 12. The bills inserted into the cabinet 12 are converted into the number of coins, and credits corresponding to the converted number of coins are added as credits owned by the player. The bill discriminator 22 is also configured to read a ticket having a bar code.

For a slot machine 1 according to the first embodiment, a coin, a bill, or electronic value information (credit) corresponding thereto is used as game media. However, a game media that can be applied to an embodiment of the present invention is not limited thereto, and, for example, a medal, a token, electronic money, and a ticket can be used.

On a front face of the top box 13, an upper image display panel 30 is provided. The upper image display panel 30 includes a liquid crystal panel and, for example, displays the accumulated amounts of the first to third jackpots, description for contents of games, or the like. On a side of the top box 13, a speaker 31 that outputs voices and audial effects is provided.

Subsequently, symbols that are drawn on outer peripheries of the reels 15L, 15C, and 15R and change to be displayed through the display windows 17L, 17C, and 17R of the lower image display panel 16 while scrolling during a game will be described with reference to FIG. 4. FIG. 4 is a schematic diagram of sets of symbol series that are drawn on outer peripheries of the reels 15L, 15C, and 15R.

On the outer peripheries of a left reel 15L, a center reel 15C, and a right reel 15R, 22 symbols are drawn, respectively. Each symbol series includes a combination of symbols among “RED7”, “BLUE7”, “BELL”, “CHERRY”, “STRAWBERRY”, “PLUM”, “ORANGE”, and “APPLE”. As shown in FIG. 4, on each one of the reels 15L, 15C, and 15R, predetermined symbols are disposed in a predetermined order.

When three of BLUE7s, CHERRYs, STRAWBERRYs, PLUMs, ORANGEs, or APPLEs are stopped to be displayed on a pay line L, a predetermined award is given to the player (see FIG. 7). In addition, even when one or two of CHERRYs or ORANGEs are stopped to be displayed on the pay line, a predetermined award depending on the number of the corresponding symbols is given to the player (see FIG. 7).

When three RED7s are stopped to be displayed on the pay line L, a predetermined award is given to the player and a bonus game is started. Here, the bonus game performed by a slot machine 1 according to the first embodiment is a selection-type bonus game that displays a plurality of options on the lower image display panel 16 and gives an award on the basis of the player's selection. The bonus game will be described later in detail.

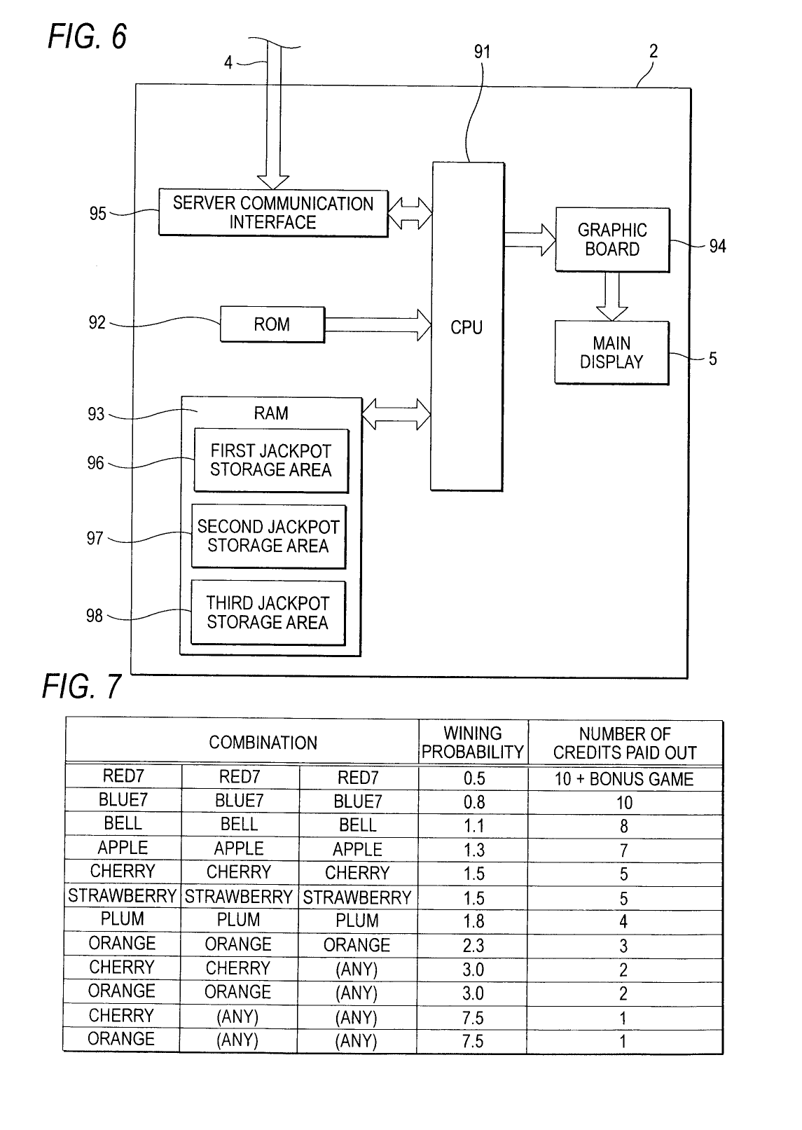

When the spin button 23 is pressed after the number of bets is determined by the operation of the 1-BET button 26 and the MAX-BET button 27, the sets of symbol series drawn on the reels 15L, 15C, and 15R shown in FIG. 4 are scrolled in an up-to-down direction to be displayed on the display windows 17L, 17C, and 17R in accordance with the rotation of the reels 15L, 15C, and 15R. Then, after a predetermined time elapses, the sets of symbol series are stopped to be displayed on the display windows 17L, 17C, and 17R in accordance with stop of the reels 15L, 15C, and 15R. In addition, various lots (see FIG. 6) are predetermined on the basis of combinations of symbols, and when the combinations of the symbols corresponding to the lots are stopped on the pay line L, an award depending on the lot stopped at the pay line is given to the player.

Next, the configuration of a control system of the slot machine 1 according to the first embodiment will be described with reference to FIG. 5. FIG. 5 is a schematic block diagram of the control system of the slot machine 1 according to the first embodiment.

As shown in FIG. 5, the control system of the slot machine 1 includes a mother board 40 and a gaming board 50 as primary components.

At first, the gaming board 50 will be described. The gaming board 50 includes a CPU 51, a ROM 55, and a boot ROM 52 which are connected with one another through an internal bus and a card slot 53S corresponding to a memory card 53 and an IC socket 54S corresponding to a GAL (Generic Array Logic) 54.

The memory card 53 includes a non-volatile memory and is a recording medium on which game programs and a game system program (hereinafter, referred to as game programs) are stored. Three types of lottery programs are included in the game programs recorded in the memory card 53. A first program is for determining symbols (code numbers corresponding to symbols) of the reels 15L, 15C, and 15R which are stopped to be displayed on the pay line L. The symbol lottery program includes symbol weighting value data corresponding to a plurality of types of payout rates (for example, 80%, 84%, and 88%). The symbol weighting value data indicates correspondence between symbol code numbers (see FIG. 4) and one or a plurality of random numbers within a predetermined number range (0 to 255) for each one of the three reels 15L, 15C, and 15R. In other words, one or a plurality of random numbers are corresponded with one symbol code number, and a random number is extracted by lottery, and whereby a symbol determined by the random number is stopped to be displayed.

A second bonus lottery program draws an award to be given to a player in a bonus game. Here, as awards for lottery, for example, there are a 1000 credit win, a 500 credit win, a 100 credit win, and the like in addition to various jackpot wins such as first jackpot win, second jackpot win, and third jackpot win.

A third accumulation lottery program draws a jackpot among the first jackpot, the second jackpot, and the third jackpot in which credits corresponding to 5% of credits betted at a time when a player performs a betting operation are accumulated.

Here the payout rate is determined on the basis of payout rate setting data that is output from the GAL 54. The various lotteries are performed on the basis of the symbol weighting value data corresponding to the payout rate.

The card slot 53S is configured such that the memory card 53 can be inserted and pulled-out into and from the card slot. The card slot is connected to the motherboard 40 through an IDE bus. Accordingly, the type or contents of the game played by the slot machine 1 can be changed by rewriting a game program or the like that is stored in the memory card 53. In addition, the type or contents of the game played by the slot machine 1 can be changed by replacing the memory card with a memory card S53 in which other game program is stored.

The game program includes a program relating to the progress of a game, image data or sound data that are output during a game, and image data or sound data as notification data.

The GAL 54 is a type of a PLD (programmable logic device) having an OR fixed-type array structure. The GAL 54 includes a plurality of input ports and a plurality of output ports. When a predetermined data is input to the input ports of the GAL 54, data corresponding to the input data is output from the output ports. The data output from the output ports is the above-described payout rate setting data.

The IC socket 54S is configured such that the GAL 54 can be attached to and detached from the IC socket 54S and is connected to the mother board 40 through the PCI bus. Accordingly, the payout setting data that is output from the GAL 54 can be changed by rewriting of the GAL 54 or replacing the GAL 54.

The CPU 51, the ROM 55, and the boot ROM 52 which are connected with one another through an internal bus are connected to the mother board 40 through the PCI bus. The PCI bus performs signal transmission between the mother board 40 and the gaming board 50 and supplies power from the mother board 40 to the gaming board 50. In the ROM 55, country identification information and an authentication program are stored. In the boot ROM 52, a preliminary authentication program, a program (boot code) for the CPU's 51 starting the preliminary authentication program, and the like are stored.

The authentication program is a program (falsification checking program) for authenticating a game program and the like. The authentication program is described in an order of a falsification checking process for a game program or the like for which an authentication input process is to be performed. The preliminary authentication program is for authenticating the above-described authentication program and is described in an order of a falsification checking process for an authentication program for which an authentication process is to be performed.

The mother board 40 will now be described. The mother board 40 includes a general-purpose mother board (a printed circuit board on which basic components of a personal computer are mounted) on the market. The mother board includes a main CPU 41, a ROM 42, a RAM 43, and a communication interface 44.

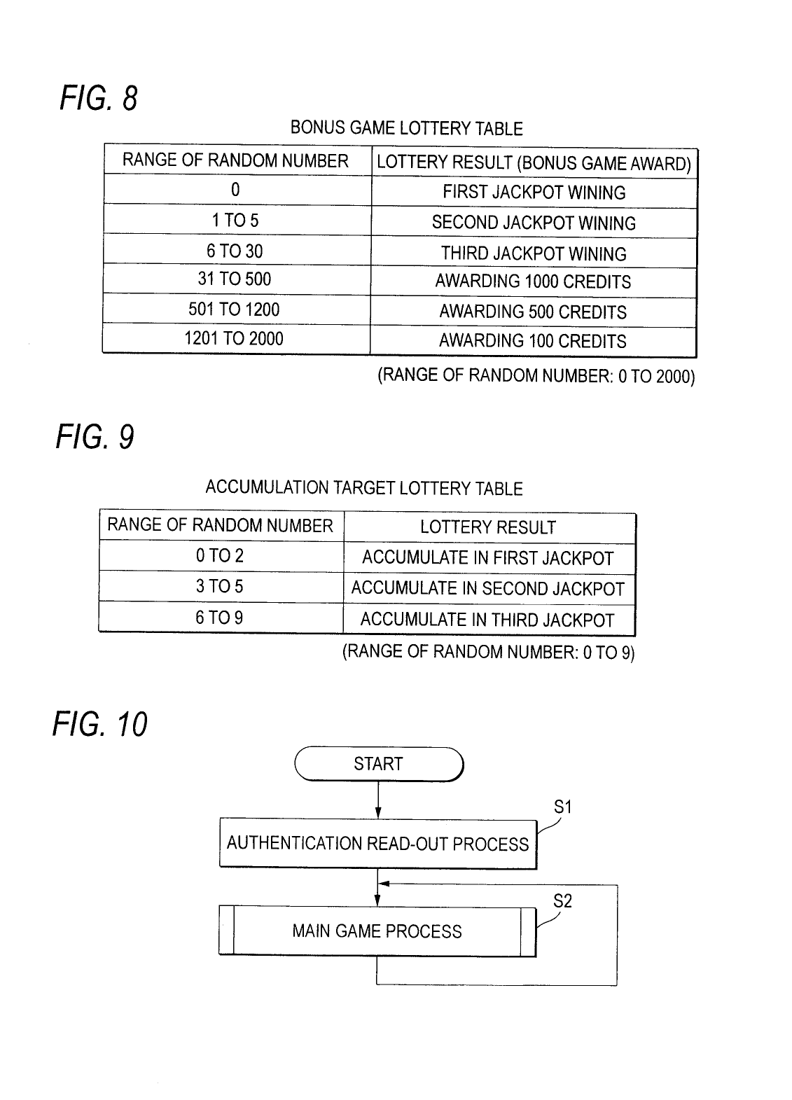

The ROM 42 includes a memory device such as a flash memory and permanent data such as a program including a BIOS executed by the main CPU 41, award and lottery tables (FIG. 6 and FIG. 7) of ordinary and bonus games, and a lottery table (FIG. 8) for drawing a jackpot to be accumulated is stored therein. When the BIOS is executed by the main CPU 41, a predetermined initializing process for peripheral devices is performed, and an input process for a game program stored in the memory card 53 or the like is started through the gaming board 50.

In the RAM 43, data or program which is used at a time when the main CPU 41 is operated is stored. In addition, the RAM 43 can store various programs, which are read out through the gaming board 50, such as an authentication program and a game program and various information such as the number of credits that a player currently owns.

The communication interface 44 is a communication device for communicating with the server 2, which is installed in the game arcade, through the network 4. The slot machine 1 communicates betting information in the main game process (See S2 of FIG. 10) to be described later, a lottery result of the lottery process, and the like with the server 2 through the communication interface 44. The configuration related to the control system of the server 2 will be described later with reference to FIG. 6.

A main PCB 60 and a door PCB 80 which will be described later are connected to the mother board 40 through USBs. In addition, a power unit 45 is connected to the mother board 40. When power is supplied from a power unit 45 to the mother board 40, the operation of the main CPU 41 of the mother board 40 is started. In addition, power is supplied to the gaming board 50 through the PCI bus, whereby the operation of the CPU 51 is started.

To the main PCB 60 and the door PCB 80, a device or an apparatus that generates an input signal for the main CPU 41 and a device or an apparatus of which operations are controlled in accordance with control signals from the main CPU 41 are connected. The main CPU 41 executes a game program or the like stored in the RAM 43 on the basis of an input signal input to the main CPU 41. By performing a predetermined arithmetic operation, the main CPU 41 performs an operation of storing the result of the arithmetic operation in the RAM 43 or a control process for each device or apparatus.

To the main PCB 60, a sub CPU 61, a hopper 66, a coin detecting unit 67, a graphic board 68, a speaker 31, a touch panel 11, and a bill discriminator 22 are connected.

Here, the touch panel 11 is disposed in a front face of the lower image display panel 16 and can determine a part the player touches and a direction in which a touched spot moves on the basis of a determined coordinate position information by determining the coordinate position of the part touched by the player.

The sub CPU 61 controls the rotation/stop of the reels 15L, 15C, and 15R. A motor driving circuit 62 having an FPGA (Field Programmable Gate Array) 63 and a driver 64 is connected to the sub CPU 61. The FPGA 63 is an electronic circuit such as a programmable LSI and serves as a control circuit for stepping motors 70L, 70C, and 70R. The driver 64 serves as an amplifier circuit for pulses that are input to the stepping motors 70L, 70C, and 70R. To the motor driving circuit 62, the stepping motors 70L, 70C, and 70R which are 1-2 phase excitation-type stepping motors for rotating the reels 15L, 15C, and 15R are connected.

In addition, an index detecting circuit 65 and a position change detecting circuit 71 are connected to the sub CPU 61. The index detecting circuit 65 detects stall of the reels 15L, 15C, and 15R together with detecting positions (for example, reference positions) of the reels 15L, 15C, and 15R during their rotation.

The position change detecting circuit 71 detects changes in the stop positions of the reels 15L, 15C, and 15R after the rotation of 15L, 15C, and 15R is stopped. For example, the position change detecting circuit 71 detects the changes in the stop position of the reels 15L, 15C, and 15R in cases where the stop position is forcedly changed to be a wining combination of symbols and the like by a player although an actual combination of symbols is not the wining combination of symbols.

The hopper 66 is installed inside the cabinet 12 and pays a predetermined number of coins from the coin payment slot 28 into the coin tray 29 on the basis of a control signal from the main CPU 41. The coin detecting unit 67 is disposed inside the coin payment slot 28. When payment of a predetermined number of coins from the coin payment slot 28 is detected, the coin detecting unit 67 outputs an input signal to the main CPU 41.

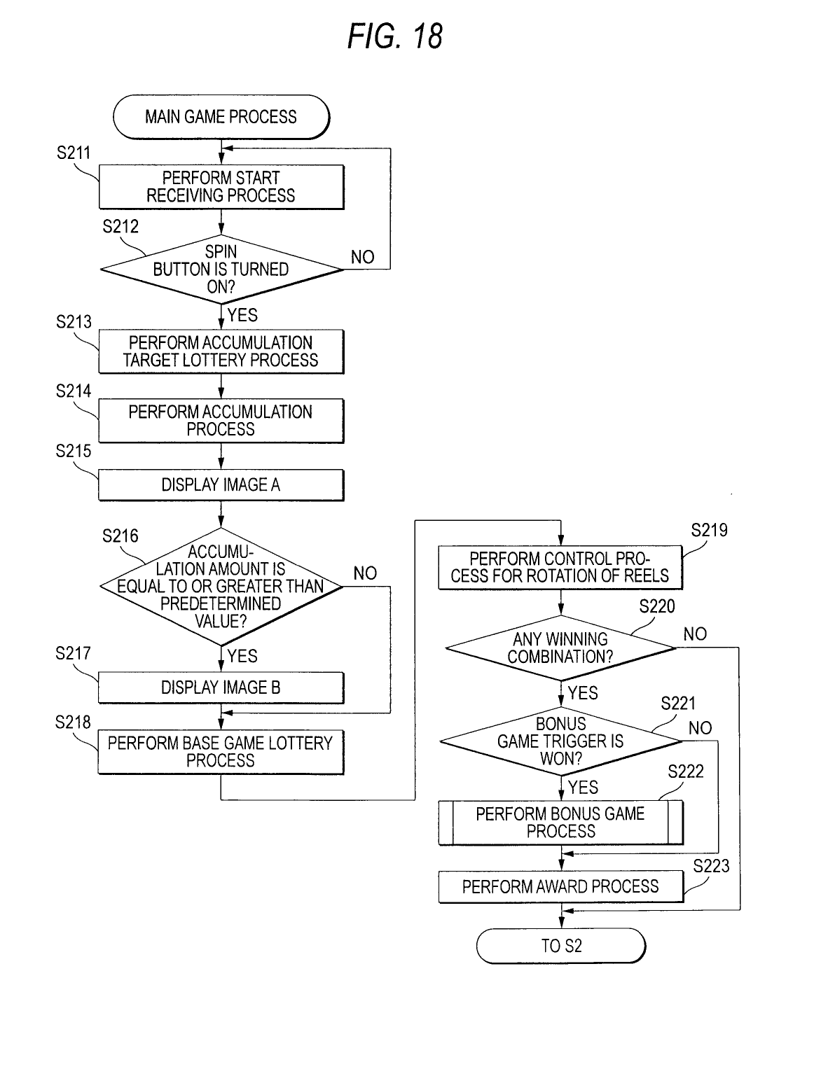

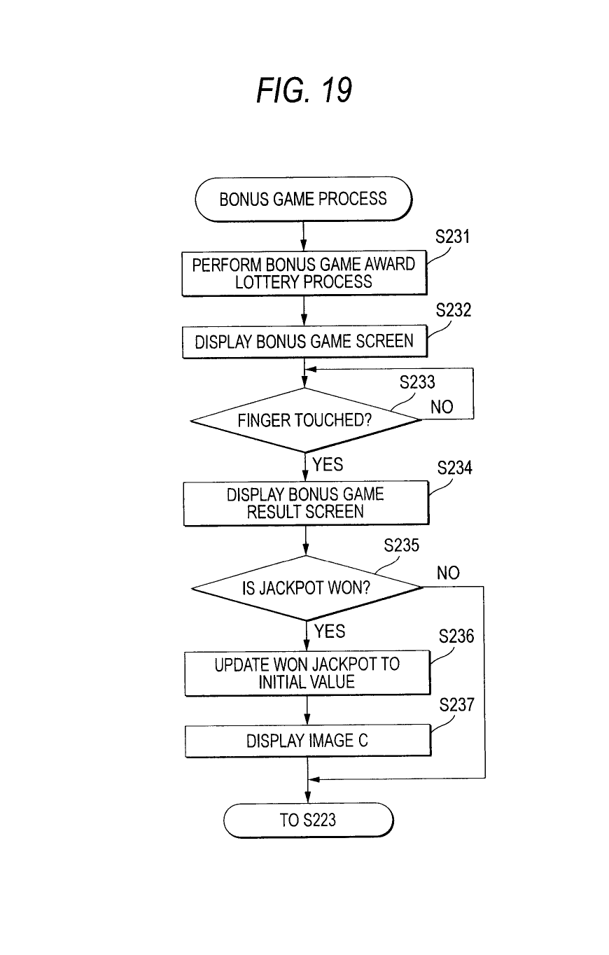

The graphic board 68 controls image display of the upper image display panel 30 and the lower image display panel 16 on the basis of a control signal from the main CPU 41. For example, the number of credits stored in the RAM 43 that a player owns is displayed in the credit amount display portion 18. The number of payments in accordance with awards is displayed in the payout amount display portion 19. During a bonus game, the image display panels are controlled so as to display bonus game screens (see FIG. 18 and FIG. 19).

Here, the graphic board 68 includes a VDP (Video Display Processor) that generates image data on the basis of a control signal from the main CPU 41 and a video RAM that sores the image data generated by the VDP. Image data used for generating the image data by the VDP is included in a game program.

The bill discriminator 22 checks the validity of a bill or a ticket to which a bar code is attached and accepts the normal bill and the normal ticket, to which the bar code is attached, inside the cabinet 12. When a normal bill is accepted, the bill discriminator 22 outputs an input signal to the main CPU 41 on the basis of the amount of the bill. In addition, the bill discriminator 22 outputs an input signal to the main CPU 41 on the basis of the number of coins recorded in the ticket to which a normal bar code is attached.

To the door PCB 80, a control panel 20, a reverter 21S, a coin counter 21C, and a cold-cathode tube 81 are connected. On the control panel 20, a spin switch 23S corresponding to the spin button 23, a change switch 24S corresponding to the change button 24, a CASHOUT switch 25S corresponding to the CASHOUT button 25, a 1-BET switch 26S corresponding to the 1-BET button 26, and a MAX-BET switch 27S corresponding to the MAX-BET button 27 are provided. When a corresponding button is operated by the player, each switch outputs an input signal to the main CPU 41.

The coin counter 21C is provided inside the coin insertion slot 21 and checks the validity of a coin that has been inserted into the coin insertion slot 21 by the player. Coins other then normal coins are discharged from the coin payment slot 28, and when a normal coin is detected, the coin counter 21C outputs an input signal to the main CPU 41.

The reverter 21S is operated on the basis of a control signal that is output from the main CPU 41. The reverter 21S distributes coins that have been recognized as normal coins into a cash box (not shown) or the hopper 66 which are installed inside the slot machine 1. The cold-cathode tube 81 is installed on a rear side of the lower image display panel 16 and the upper image display panel 30. The cold-cathode tube 81 is lighted on the basis of a control signal from the main CPU 41 and serves as a back light.

Subsequently, a configuration of a control system of the server 2 according to the first embodiment will be described with reference to FIG. 6. FIG. 6 is a schematic block diagram showing the control system of the server 2 according to the first embodiment.

As shown in FIG. 6, the control system of the server 2 includes a CPU 91, a ROM 92, a RAM 93, a graphic board 94, and a server communication interface 95 which are connected with one another through an internal bus.

The ROM 92 is implemented by a memory device such as a flash memory, and stores a permanent data for an accumulation process for jackpots executed by the CPU 91, a communication program for communication between the ROM 92 and the slot machine 1, and the like.

In the RAM 93, data or program that is used for operations of the CPU 91 is stored. In addition, in the RAM 93, a first jackpot storing area 96 that stores the accumulated amount of the first jackpot, a second jackpot storing area 97 that stores the accumulated amount of the second jackpot, and a third jackpot storing area 98 that stores the accumulated amount of the third jackpot are provided. When betting information and determining information for determining the type of the jackpot for accumulation are transmitted from the slot machine 1, the CPU 91 reads out the accumulated amount of credits that are accumulated in the first to third jackpot storing areas 96 to 98 corresponding to the type of the jackpot determined by the lottery result, adds 5% of the credits betted by the slot machine 1 to the read-out accumulated amount, and stores the resultant accumulated amount in the corresponding jackpot storing area as the accumulated amount.

The graphic board 94 controls image display of the main display 5 on the basis of a control signal from the CPU 91. To be more specific, the main display 5 is controlled so as to display fish images (see FIG. 1) that indirectly indicate the accumulated amounts currently accumulated from the initial values in the first jackpot, the second jackpot, and the third jackpot.

Here, the graphic board 94 includes a VDP (Video Display Processor) that generates image data on the basis of a control signal from the main CPU 91 and a video RAM that sores the image data generated by the VDP. Image data used for generating the image data by the VDP is included in the ROM 92.

Next, winning combinations and corresponding awards in a case where a base game is played by the slot machine 1 according to the first embodiment using the reels 15L, 15C, and 15R will be described with reference to FIG. 7. FIG. 7 is an award table showing winning combinations and corresponding winning probabilities and awards in a case where a game is played using the reels 15L, 15C, and 15R.

The awards shown in FIG. 7 are in a case where the number of bet is one. Thus, when the number of the bet is one, the award values shown in FIG. 7 are added to the credits. However, when the number of bets is two or more, values obtained by multiplying the award values shown in FIG. 6 by the corresponding number of bets are added to the credits.

The winning probabilities of the winning combinations shown in FIG. 7 are values in a case where the payout rate is 88% in games other than bonus games. The wining probabilities shown in the figure indicate the winning probabilities of corresponding lots in a case where the code numbers of the reels 15L, 15C, and 15R are determined on the basis of three random numbers with reference to symbol weighting value data. In other words, random numbers are not corresponded with the winning combinations, respectively.

For example, the probability of a bonus game trigger is 0.5%. When the bonus game trigger is won, three symbols of RED7s are stopped to be displayed in the pay line and a bonus game is given together with being paid out with 10 credits as an award.

The wining probability of BLUE7 is 0.8%. When this lot is won, three symbols of BLUE7s are stopped to be displayed in the pay line and the combination of the accumulated amounts of jackpots is performed together with being paid out with 10 credits per one bet as an award.

The wining probability of BELL is 1.1%. When this lot is won, three symbols of BELLs are stopped to be displayed in the pay line and 8 credits per one bet are given as an award.

The winning probability and the number of credits paid out are set for each combination, shown in FIG. 6, including the combinations thereafter. When a combination of symbols not corresponding to any combination of the winning lots shown in FIG. 6 is stopped to be displayed, a lot is not won and, accordingly, credits are not paid out.

Next, a bonus game lottery table that is used for determining an award for a bonus game performed by the slot machine 1 according to the first embodiment will be described with reference to FIG. 8. FIG. 8 is a diagram showing a bonus game lottery table according to the first embodiment.

As shown in FIG. 8, the bonus game lottery table includes a predetermined range of random numbers and awards corresponding to the range of random number values. Here, the range of random number values used for lottery of an award in a bonus game is 0 to 2000, and the random number is sampled by a lottery program executed by the main CPU 41.

To be more specific, a range of a random number value of 0 is corresponded with wining the first jackpot. A range of random number values of 1 to 5 is corresponded with wining the second jackpot. A range of random number values of 6 to 30 is corresponded with wining the third jackpot. A range of random number values of 31 to 500 is corresponded with an award of 1000 credits. A range of random number values of 501 to 1200 is corresponded with an award of 500 credits. A range of random number values of 1201 to 2000 is corresponded with an award of 100 credits.

When each jackpot is won, the main CPU 41 awards credits corresponding to an amount currently accumulated in the corresponding jackpot. In addition, when each award of credits is won, the main CPU 41 gives credits of the corresponding amount.

Next, an accumulation target lottery table that is used for selecting a jackpot for which an accumulation is performed at a time when the player bets using the slot machine 1 according to the first embodiment will be described with reference to FIG. 9. FIG. 9 is a diagram showing an accumulation target lottery table according to the first embodiment.

As shown in FIG. 9, the accumulation target lottery table includes predetermined ranges of random numbers and types of jackpots corresponded with the ranges of the random number values. Here, the range of random number values that are used for drawing a jackpot for which the accumulation is performed is 0 to 9, and the random number value is sampled by a lottery program executed by the main CPU 41.

To be more specific, the first jackpot as a target jackpot for accumulation is corresponded with a random number value in the range of 0 to 2. In addition, the second jackpot as a target jackpot for accumulation is corresponded with a random number value in the range of 3 to 5. In addition, the third jackpot as a target jackpot for accumulation is corresponded with a random number value in the range of 6 to 9.

The CPU 91 reads out the accumulated amount of credits that are accumulated in the first to third jackpot storing areas 96 to 98 corresponding to the type of the jackpot determined by the lottery result, adds 5% of the credits betted by the slot machine 1 to the read-out accumulated amount, and stores the resultant accumulated amount in the corresponding jackpot storing area as the accumulated amount.

Subsequently, a main control program that is executed in the slot machine 1 according to the first embodiment will be described in detail with reference to the accompanying drawings. FIG. 9 is a flowchart of the main control program.

It is assumed that the memory card 53 is inserted into the card slot 53S of the gaming board 50 of the slot machine 1 and the GAL 54 is attached to the IC socket 54S.

At first, when a power switch of the power unit 45 is turned on (power is delivered), the operations of the mother board 40 and the gaming board 50 are started, and whereby an authentication read-out process of a step (hereinafter, referred to as S) 1 is performed. In the authentication read-out process, the mother board 40 and the gaming board 50 perform separate processes in a parallel manner.

In other words, in the gaming board 50, the CPU 51 reads out a preliminary authentication program stored in the boot ROM 52 and performs a preliminary authentication operation for checking/verifying that the authentication program has not been modified in advance before being inputted to the mother board 40 on the basis of the read-out preliminary authentication program.

In the mother board 40, the main CPU 41 executes the BOIS stored in the ROM 42, decompresses compressed data stored in the BIOS and stores the resultant data in the RAM 43, and performs execution of the BIOS decompressed in the RAM 43 and diagnosis and initialization processes for various peripheral devices.

Thereafter, the main CPU 41 reads out an authentication program stored in the ROM 55 and performs an authentication process of checking and verifying that a game program or the like stored in the memory card 53 inserted into the card slot 53S is not modified. When this authentication process is normally completed, the main CPU 41 stores the game program or the like that has been the target for the authentication process (authenticated) in the RAM 43 and acquires the payout rate setting data and country identification information.

After the above-described processes are performed, the main CPU 41 ends the authentication read-out process.

In S2, the main CPU 41 sequentially reads out the game program and the like, that have been authenticated by the authentication read-out process of S1, from the RAM 43 for execution and performs a main game process (S2), and whereby the game in the slot machine 1 according to the first embodiment is performed. The main game process is repeatedly performed while power is supplied to the slot machine 1.

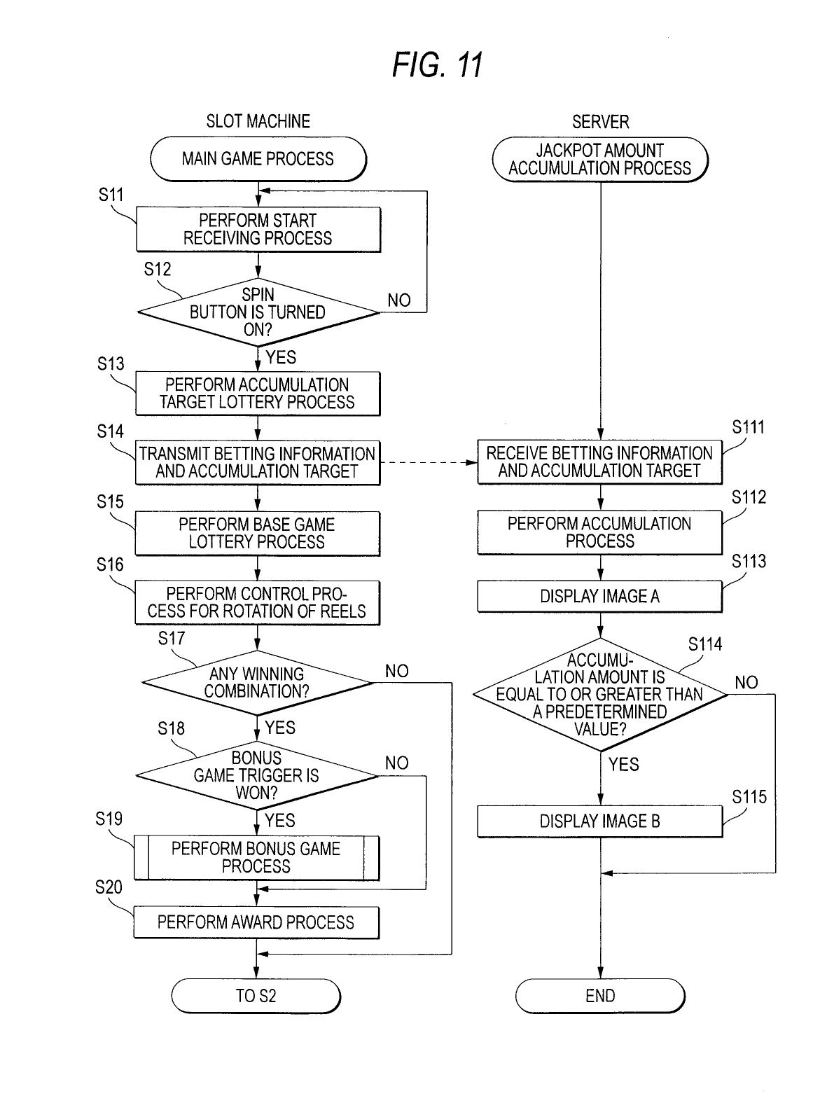

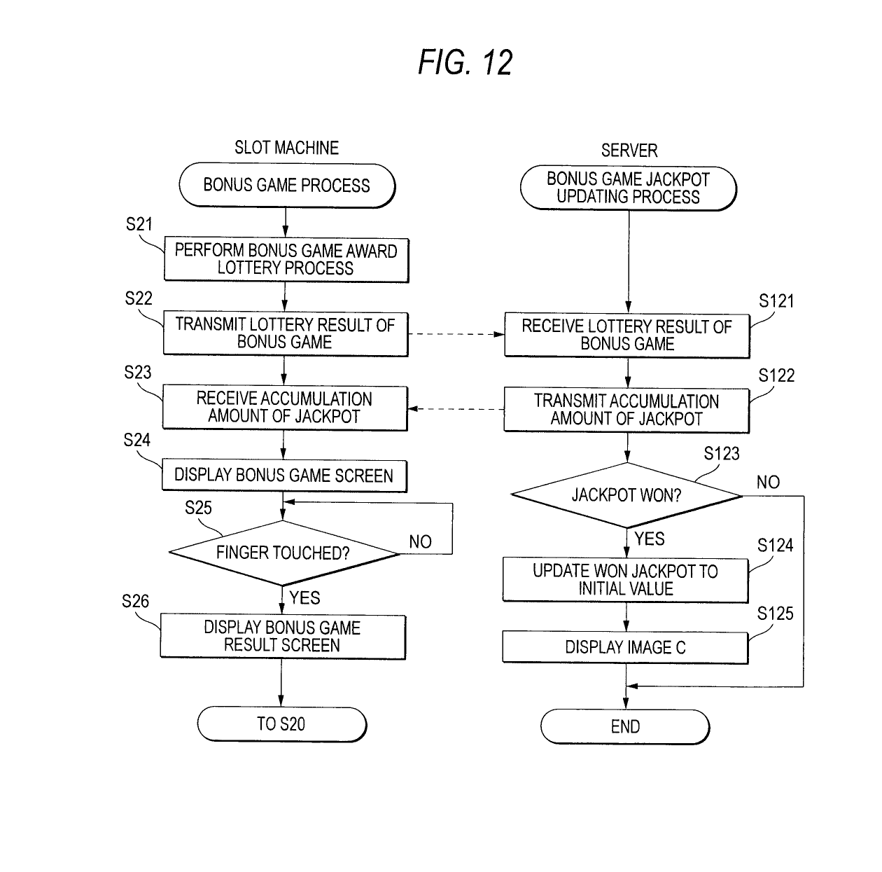

Next, an accumulation process of jackpot amounts that is performed by the server 2 in parallel with a subsidiary process of the main game process S2 will be described with reference to FIG. 11. FIG. 11 shows flowcharts of a program for the main game process in the slot machine 1 according to the first embodiment and a program for a jackpot amount accumulation process in the server 2. The programs for flowcharts shown in FIGS. 11 and 12 are stored respectively in the ROMs 42 and 92 or the RAMs 43 and 93 that are included respectively in the slot machine 1 or the server 2 and are executed respectively by the main CPU 41 or the CPU 91.

At first, the main game process executed by the slot machine 1 will be described with reference to FIG. 11. In S11, the main CPU 41 performs a start receiving process in which coins are inserted or the number of bets for the pay line or the like is set after performing a predetermined initial setting. In the start receiving process, the insertion of coins into the coin insertion slot 21 is performed by a player and a betting operation using the 1-BET button 26 and the MAX-BET button 27 is performed on the basis of credits stored in accordance with the number of coins inserted or the remaining credits in the previous game. The main CPU 41 detects the number of coins inserted into the coin insertion slot 21 and the betting operation using the 1-BET button 26 and the MAX-BET button 27.

Next, in S12, the main CPU 41 determines whether the spin button 23 is pressed. Whether the spin button 23 is pressed is determined based on whether an input signal from the spin switch 23S is received.

When the spin button 23 is not pressed (S12: NO), the process is moved back to the start receiving process (S11). At this time, an operation such as an operation for change in the number of bets can be performed. On the other hand, when the spin button 23 is pressed (S12: YES), the number of bets set for the pay line L on the basis of the operations of the 1-BET button 26 and the MAX-BET button 27 is subtracted from the number of credits owned and is stored in the RAM 43 as betting information.

Thereafter, in S13, the main CPU 41 performs an accumulation target lottery process in which drawing a jackpot to be accumulated in this game is performed. To be more specific, the main CPU 41 selects a random number value in the range of 0 to 9 by executing a program for generation of random numbers included in a lottery program that is stored in the RAM 43. Then, the main CPU 41 selects one jackpot to be accumulated among the first jackpot, the second jackpot, and the third jackpot with reference to the accumulation target lottery table (FIG. 8).

In S14, information on the type of the jackpot that has been selected to be the accumulation target is transmitted to the server 2 on the basis of the betting information that has been received in S11 and the lottery result of the lottery process in S13. The server 2 accumulates the amount of the jackpot on the basis of the transmitted information, as described below.

In S15, the main CPU 41 performs a base game process using the reels 15L, 15C, and 15R. To be more specific, the main CPU 41 selects random number values in the range of 0 to 255 for the three reels 15L, 15C, and 15R by executing the program for the generation of random numbers included in the lottery program that is stored in the RAM 43. Then, the code numbers (see FIG. 4) of the reels 15L, 15C, and 15R are determined on the basis of the selected three random number values with reference to the symbol weighting value data in accordance with the payout rate setting data. The determined code numbers of the reels 15L, 15C, and 15R are stored in the RAM 43, and then, the process proceeds to S16.

Here, since the code numbers of the reels 15L, 15C, and 15R correspond to the codes of symbols that stop to be displayed on the pay line L, the lot in the corresponding game is determined by the CPU 41's determining the code numbers of the reels 15L, 15C, and 15R. For example, when the code numbers of the reels 15L, 15C, and 15R are determined respectively to be “00”, “00”, and “00”, the main CPU 41 determines the lot to be RED7 as a result. As described above, by determining the code numbers of the reels 15L, 15C, and 15R, a lottery operation related with a base combination (see FIG. 7) is performed.

In S16, the main CPU 41 performs a control process for rotation of the reels. The control process for rotation of the reels stops the rotation of the reels 15L, 15C, and 15R after the rotation of the whole reels 15L, 15C, and 15R is started, so that a combination of symbols that is determined by the base game lottery process (S15) is stopped to be displayed on the pay line L. This process is performed between the main CPU 41 and the sub CPU 61.

To be more specific, at first, the main CPU 41 transmits a start signal for starting the rotation of the reels to the sub CPU 61 in the control process (S16) for rotation of the reels. When receiving the start signal, the sub CPU 61 performs a process for rotation of the reels. In other words, the sub CPU 61 drives the stepping motors 70L, 70C, and 70R by using the motor driving circuit 62 and the driver 64, whereby rotation of the reels 15L, 15C, 15R is started.

After the transmission of the start signal, the main CPU 41 determines a representation mode (a mode such as image display on the lower image display panel 16 or voice output using the speaker 31) and starts the representation of the determined representation pattern.

Thereafter, when a predetermined stopping timing at which the rotation of the reels 15L, 15C, and 15R is stopped is reached, the main CPU 41 transmits the code numbers of the reels stored in the RAM 43 to the sub CPU 61. The sub CPU 61 performs a reel stopping process on the basis of the code numbers of the reels. Accordingly, the symbols corresponding to the result of the lottery are stopped to be displayed on the pay line L of the display windows 17L, 17C, and 17R.

In S17, the main CPU 41 determines whether a corresponding slot machine 1 has won any one of winning combinations in a base game. As a result of the determination, when it is determined that any one of the wining combinations shown in FIG. 7 is won (S17: YES), the process proceeds to S18. On the other hand, when any one of the wining combinations is not won (S17: NO), the corresponding main game process ends.

Next, the main CPU 41 determines whether a bonus game trigger is won in a base game in S18. To be more specific it is determined that the bonus game trigger is won when a combination of symbols of RED7s is stopped to be displayed on the pay line L.

When it is determined that the bonus trigger is won (S8: YES), a bonus game process (S19) to be described later is performed, and then, awards acquired in a base game and a bonus game are given to the player (S20). When one of the jackpots is won in a bonus game, the currently accumulated amount in the corresponding jackpot is paid as an award. At this moment, coins (one credit corresponds to one coin) corresponding to the number of credits may be paid by pressing the CASHOUT button 25, or a ticket to which a bar code is attached may be given.

On the other hand, when it is determined that the bonus trigger is not won (S18: NO), the award acquired in the base game is given to the player (S20). Thereafter, the process is moved back to S2 for repeatedly performing the main game process.

Next, the jackpot amount accumulation process performed by the server 2 will be described with reference to FIG. 11. In S111, the CPU 91 receives betting information that is information on the betting of a player and information on the type of a jackpot that has been selected as an accumulation target through the network 4 from the slot machine 1 connected thereto.

Thereafter, the CPU 91 performs an accumulation process of the jackpot in S112. To be more specific, the CPU 91 reads out the accumulation amount of credits accumulated in first to third jackpot storage areas 96 to 98 corresponding to the type of jackpot that has been selected as a target for accumulation (the first jackpot storage area 96 in a case where the first jackpot is selected, the second jackpot storage area 97 in a case where the second jackpot is selected, and the third jackpot storage area 98 in a case where the third jackpot is selected). Thereafter, the CPU 91 calculates the amount corresponding to 5% of credits betted by using the slot machine 1 on the basis of the received betting information, adds the calculated number of credits to the read-out accumulation amount, and stores back the resultant accumulation amount in the RAM 93.

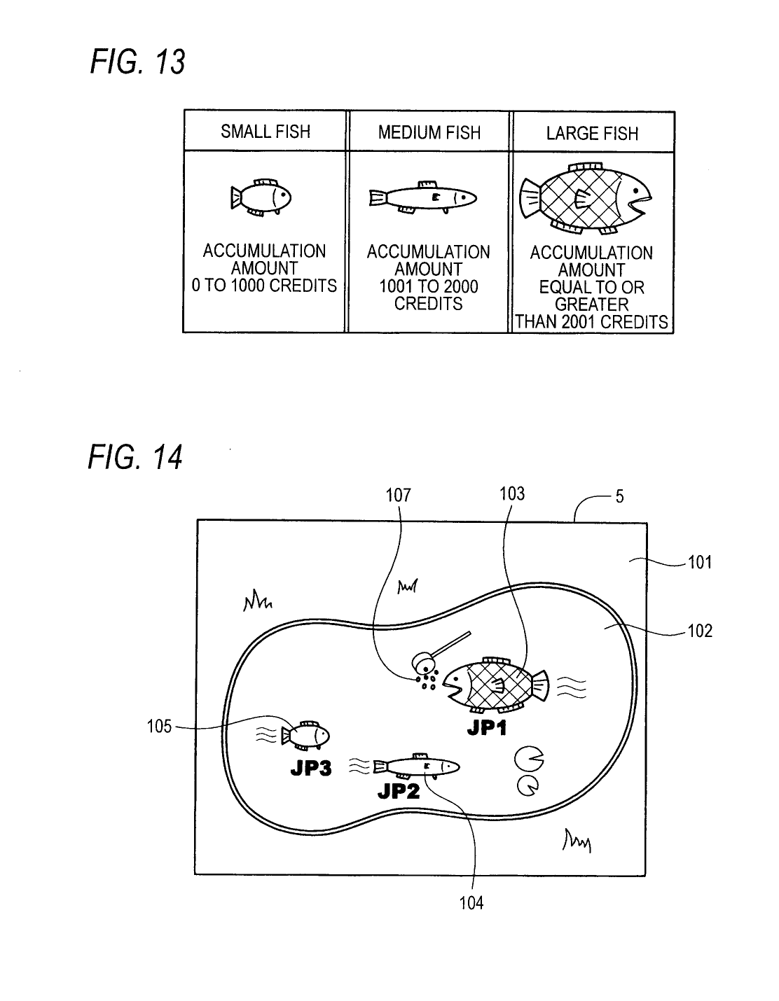

Thereafter, the CPU 91 controls the main display 5 so as to display an image A in S113. Here, the image A is an image in which there is displayed feeding a fish among three fish, swimming in a jackpot amount display screen 101 displayed on the main display 5, that corresponds to the jackpot of which the accumulation amount is added in S112. Here, FIG. 13 is a diagram showing the jackpot amount display screen 101 displayed on the main display 5 of the game system 3 according to the first embodiment.

The server 2 according to the first embodiment displays the jackpot amount display screen 101 shown in FIG. 1 on the main display 5 regardless whether gaming is performed using the slot machines 1 connected thereto. As shown in FIG. 1, the jackpot amount display screen 101 includes a pond 102 and three fish of a first fish 103, a second fish 104, and a third fish 105 that swim in the pond 102. In addition, a text of “JP1” is displayed below the first fish 103, a text of “JP2” is displayed below the second fish 104, and a text of “JP3” is displayed below the third fish 105.

Here, the first to third fish 103 to 105 are character images indirectly indicating the accumulation amounts currently accumulated in the first to third jackpots from initial values, respectively. As shown in FIG. 13, fish images used for the first to third fish 103 to 105 include three types of images that are corresponded with different value ranges. For example, when the accumulation amount is in the range of 0 to 1000 credits, the accumulation amount is represented as an image of a small fish. When the accumulation amount is in the range of 1001 to 2000 credits, the accumulation amount is represented as an image of a medium fish that is grown from the small fish. When the accumulation amount is equal to or larger than 2001 credits, the accumulation amount is represented as an image of a large fish that is grown from the medium fish. Accordingly, the player can easily recognize the accumulation amounts of the three types of the jackpots by looking at the first to third fish 103 to 105 displayed on the main display 5.

For example, the player can notice that the accumulation amount of the first jackpot is larger than 2001 credits, the accumulation amount of the second jackpot is in the range of 1001 to 2000 credits, and the accumulation amount of the third jackpot is in the range of 0 to 1000 credits, by the player's referring to the jackpot amount display screen 101 as shown in FIG. 1.

In S113, as shown in FIG. 14, there is displayed an image A in which, among the three fish of first fish 103 to third fish 105 that swim in the jackpot amount display screen 101, a fish corresponding to the jackpot, the accumulation amount of which has been added in S112 (for example, the first fish 103 shown in FIG. 14) is given meal 107 and the fish eats the given meal 107. By displaying the image, the player is informed of the type of the jackpot that has been a target for the accumulation on the basis of the player's betting performed in this game by using the slot machine 1.

In S114, the CPU 91 determines whether the accumulation amount of the jackpot accumulated by the accumulation process of S112 is equal to or greater than a predetermined value (in the first embodiment, 1001 credits or 2001 credits). When it is determined that the accumulation amount is equal to or greater than a predetermined value (S114; YES), the CPU 91 controls the main display 5 so as to display an image B (S115). Here, the image B is an image in which fish images of the first fish 103 to third fish 105 displayed in the jackpot amount display screen 101 are changed into further grown fish. For example, when the accumulation amount is equal to or greater than 1001 credits, there is displayed the image B in which corresponding images of the first fish 103 to the third fish 105 are changed from images of small fish into images of middle-sized fish. When the accumulation amount is equal to or greater than 2001 credits, there is displayed the image B in which corresponding images of the first fish 103 to the third fish 105 are changed from images of middle fish into images of large fish.

On the other hand, when it is determined that the accumulation amount is not equal to or greater than the predetermined value (S114; NO), the CPU 91 ends the corresponding jackpot amount accumulation process.

Next, a subsidiary process of the bonus game process of S19 that is performed by the slot machine 1 according to the first embodiment and a bonus game jackpot updating process performed in parallel with the bonus game process by the server 2 will be described with reference to FIG. 12. FIG. 12 shows flowcharts of a program for a bonus game process in the slot machine 1 according to the first embodiment and a program for the bonus game jackpot updating process of the server 2.

First, the bonus game process performed by the slot machine 1 will be described with reference to FIG. 12. In S21, the main CPU 41 draws an award to be given to the player playing a bonus game. To be more specific, the main CPU 41 samples a random number value in the range of 0 to 2000 by executing a random number generating program in a lottery program that is stored in the RAM 43. Then, the main CPU 41 selects one among a first jackpot wining, a second jackpot winning, a third jackpot wining, a 1000 credit awarding, a 500 credit awarding, and a 100 credit awarding as an award given to the player in a bonus game with reference to the bonus game lottery table (FIG. 8).

In S22, the main CPU 41 transmits information on the awarding given to the player using the bonus game on the basis of a lottery result of the lottery process of S21 to the server 2. The server 2 updates the jackpot amount on the basis of the transmitted information as described below.

Thereafter, in S23, the main CPU 41 receives the current accumulation amounts of the jackpots that have been transmitted from the server 2. Then, the main CPU 41 calculates the wining amounts to be given to the player on the basis of the received jackpot amounts and the lottery result from S21 for a case where one of the jackpots is won. Next, in S24, the main CPU 41 displays a bonus game screen 111 in the lower image display panel 16. Here, FIG. 15 is a diagram showing the bonus game screen 111 displayed on the lower image display panel 16 of the slot machine 1.

As shown in FIG. 15, the bonus game screen 111 includes the four cards 112 to 115 displayed in the lower side of the bonus game screen 111. In order to enable the player to easily recognize images of cards 112 to 115, the display windows 17L, 17C, and 17R are displayed without overlapping the images of the cards 112 to 115.

Next, in S25, it is determined whether a finger of the player contacts any one of the cards 112 to 115 displayed on the bonus game screen 111 on the basis of the operation information transmitted from the touch panel 11. When it is determined that any one of the cards is not touched (S25; NO), the process waits for the touch of any one of the cards. On the other hand, when it is determined that any one of the cards is touched (S25; YES), the process proceeds to S26.

In S26, the main CPU 41 controls the main display 5 so as to display a result screen of the bonus game. Here, the result screen of the bonus game is a screen in which a winning amount for the bonus game selected in S21 is displayed by turning up a card among the four cards 112 to 115 displayed on the bonus game screen 111 that is contacted by the player. After displaying the result screen of the bonus game, the process proceeds to S20 of an awarding process and an award acquired by the bonus game is given.

Here, FIG. 16 is a case where the third jackpot wining is selected as an award by the bonus game award lottery process of S21 and shows the bonus game screen 111 in a case where the card 114 is selected by the player. As shown in FIG. 16, among the four cards 112 to 115 displayed in the bonus game screen 111, for example, in a case where the card 114 is touched by a finger of the player, a representation process for displaying a text 116 of “JP3” indicating the third jackpot win by turning up the card 114 is performed. When the cards 112, 113, and 115 are touched by the player, representation processes for displaying the text 116 of “JP3” indicating the third jackpot win by turning up the cards 112, 113, 115 are performed, respectively. By this representation, the player can notice the wining amount acquired by this bonus game.

Next, the bonus game jackpot updating process performed by the server 2 will be described with reference to FIG. 12. In S121, the CPU 91 receives information on the bonus game lottery result through the network 4 from the slot machine 1 connected thereto.

In S122, the CPU 91 sequentially transmits the accumulation amounts currently accumulated in the jackpots (the first jackpot, the second jackpot, and the third jackpot) to the slot machine 1 that has transmitted the bonus game lottery result.

Thereafter, in S123, the CPU 91 determines whether one among the first jackpot, the second jackpot, and the third jackpot is won on the basis of the lottery result of the bonus game received in S121.

When it is determined that one jackpot is won (S123; YES), the accumulation amount of the won jackpot is updated to an initial value (S124). To be more specific, the CPU 91 reads out the accumulation amount of credits accumulated in the first to third jackpot storage areas 96 to 98 corresponding to the type of jackpot that has been won (the first jackpot storage area 96 in a case where the first jackpot is won, the second jackpot storage area 97 in a case where the second jackpot is won, and the third jackpot storage area 98 in a case where the third jackpot is won) from the RAM 43. Thereafter, the read-out accumulation amount is changed to an initial value (for example, 2000 credits for the first jackpot, 1000 credits for the second jackpot, and 500 credits for the third jackpot) set in advance in the corresponding jackpot and the changed accumulation amount is stored back in the RAM 93.

In S125, the CPU 91 controls the main display 5 so as to display an image C. Here, the image C is an image in which, among three fish of the first fish 103 to the third fish 105 displayed in the jackpot amount display screen 101 (see FIG. 1), an image of the fish corresponding to the jackpot of which accumulation amount is changed to the initial value in S124 is changed to a small fish before being grown. For example, when a jackpot of which accumulation amount is in the range of 1001 credits to 2000 credits is won, there is displayed the image D in which an image of the corresponding fish among the first to third fish 103 to 105 is changed from an image of a medium fish to an image of a small fish. When a jackpot of which accumulation amount is equal to or greater than 2001 credits is won, there is displayed the image C in which an image of the corresponding fish among the first to third fish 103 to 105 is changed from an image of a large fish to an image of a small fish. On the other hand, when a jackpot of which accumulation amount is smaller than 1001 credits is won, the image C is displayed without changing an image of corresponding fish among the first to third fish 103 to 105 from an image of a small fish.

On the other hand, when it is determined that no jackpot is won in S123 (S123; NO), the corresponding bonus game jackpot updating process ends.

As described above, in a game system 3 and a slot machine 1 according to the first embodiment of the present invention, a betting operation is performed on the basis of inserted coins, a lottery process of selecting a target jackpot among the first jackpot, the second jackpot, and the third jackpot in which credits corresponding to a predetermined rate for betted credits are accumulated is performed (S13), and predetermined credits are accumulated in the jackpot selected on the basis of the lottery result (S112), and accordingly, by providing a plurality of jackpots, increasing rates of credits accumulated in the jackpots can be changed by randomly changing a target jackpot for accumulation while the expectation of a player for the result of a game in relation with acquisition of the jackpots is increased. Accordingly, various games can be implemented in the slot machine that has progressive bonuses.

In addition, since the jackpot amount display screen 101 is displayed on the main display 5 and the accumulation amounts of credits currently accumulated in the jackpots are indicated by the image types of three fishes of the first fish 103 to the third fish 105 that swim in the jackpot amount display screen 101, it becomes possible to allow the player ambiguously recognize the accumulation amounts of the plurality of jackpots accumulated from initial values. As a result, it becomes possible to allow the player guess the accumulation amount of the jackpots, and whereby the player's taste for the game is increased. In addition, differences among the accumulation amounts of the jackpots can be easily recognized at once, and whereby the recognizability of the differences among the accumulation amounts is improved, compared to a case where the accumulation amounts of the jackpots are indicated specifically by numbers or the like. Accordingly, the player's expectation for wining the jackpot having high accumulation amounts before long is increased.

### Second Embodiment

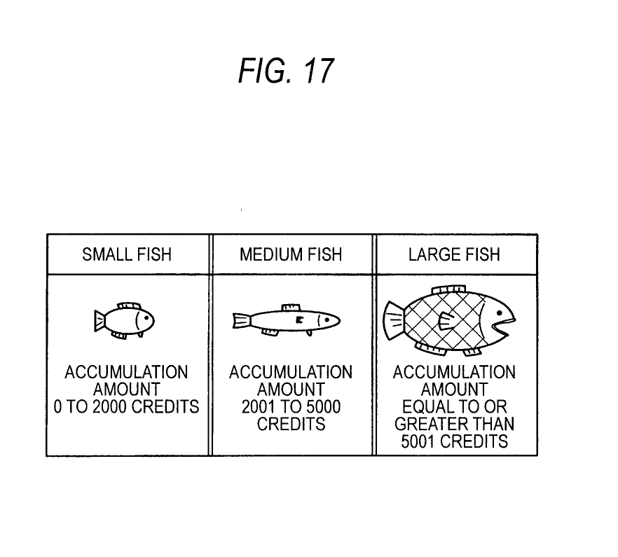

Next, a game system according to a second embodiment of the present invention will be described with reference to FIG. 17. In descriptions below, signs that are the same as the signs in the configuration of the game system 3 shown in FIGS. 1 to 16 according to the first embodiment of the invention denote the same or corresponding parts in the configurations of the game system 3 and the like according to the first embodiment.

A schematic configuration of the second embodiment is almost the same as the game system 3 according to the first embodiment. In addition, various control processes in the second embodiment is almost the same as those in the game system 3 according to the first embodiment.

However, while the game system 3 according to the first embodiment indicates the accumulation amounts of the plurality of jackpots of the first jackpot, the second jackpot, and the third jackpot from corresponding initial values by using images of the first fish 103 to the third fish 105 displayed on the jackpot amount display screen 101, the game system according to the second embodiment displays accumulation amounts of the first jackpot, the second jackpot, and the third jackpot including corresponding initial values by using images of the first fish 103 to the third fish 105 displayed in the jackpot amount display screen 101, which is different from the game system 3 according to the first embodiment.

Here, FIG. 17 is a diagram showing the first fish 103 to the third fish 105 used on the jackpot amount display screen 101 (see FIG. 1) that is displayed in the main display 5 of the game system according to the second embodiment. The first to third fish 103 to 105 are character images indirectly indicating the accumulation amounts (including initial values) currently accumulated in the first to third jackpots, respectively. As shown in FIG. 17, fish images used for the first to third fish 103 to 105 include three types of images that are corresponded with different value ranges. For example, when the accumulation amount is in the range of 0 to 2000 credits, the accumulation amount is represented as an image of a small fish. When the accumulation amount is in the range of 2001 to 5000 credits, the accumulation amount is represented as an image of a medium fish that is grown from the small fish. When the accumulation amount is equal to or larger than 5001 credits, the accumulation amount is represented as an image of a large fish that is grown from the medium fish. Accordingly, the player can easily recognize the accumulation amounts of the three types of the jackpots by looking at the first to third fish 103 to 105 displayed on the main display 5.

For the above described jackpot amount accumulation process (FIG. 11) performed by the server 2, it is determined whether the accumulation amount of the jackpot including an initial value is equal to or greater than 2001 credits or 5001 credits in the process of S114 of the game system according to the second embodiment. Then, it is controlled that the image B in which the images of the first fish 103 to the third fish 105 are changed on the basis of the result of the determination is displayed (S115).

As described above, in the game system 3 and the slot machine 1 according to the second embodiment, since the jackpot amount display screen 101 are displayed on the main display 5 and the accumulation amounts of credits currently accumulated in the jackpots is displayed by using image types of three fish of the first fish 103 to the third fish 105 swimming on the jackpot amount display screen 101, it becomes possible to increase the taste of a player.

### Third Embodiment

Next, a slot machine according to a third embodiment of the present invention will be described with reference to FIGS. 18 and 19. In descriptions below, signs that are the same as the signs in the configuration of the slot machine 1 shown in FIGS. 1 to 16 according to the first embodiment of the invention denote the same or corresponding parts in the configurations of the slot machine 1 and the like according to the first embodiment.

A schematic configuration of the third embodiment is almost the same as the slot machine 1 according to the first embodiment. In addition, various control processes in the third embodiment are almost the same as those in the slot machine 1 according to the first embodiment.

However, while in the slot machine 1 according to the first embodiment, a value storing means that stores accumulation amounts of the jackpots and an image displaying means that displays the jackpot amount display screen 101 are provided in an external server 2 and the jackpot accumulation process and the display process of the jackpot amount display screen 101 are performed by the server 2, the slot machine according to the third embodiment includes the value storing means and the image displaying means therein and the jackpot accumulation process and the display process of the jackpot amount display screen 101 are performed by the slot machine according to the third embodiment instead of the server 2, which is different from the slot machine 1 according to the first embodiment.

A subsidiary process of a main game process of the slot machine according to the third embodiment will now be described with reference to FIG. 18. FIG. 18 is a flowchart of a program for the main game process in the slot machine according to the third embodiment.

Here, the processes of S211 to S213 and S218 to S223 are the same as the processes of S11 to S13 and S15 to S20 of the main game process (FIG. 11) in the above-described first embodiment, and accordingly, description thereof is omitted here. The slot machine according to the third embodiment includes first jackpot storage area 96 to the third jackpot storage area 98 for storing the accumulation amount of the jackpots in the RAM 43.

Next, in S214, the main CPU 41 performs the accumulation process of the jackpots. To be more specific, the main CPU 41 reads out the accumulation amount of credits accumulated in the first to third jackpot storage areas 96 to 98 corresponding to the type of jackpot that has been selected as a target for accumulation (the first jackpot storage area 96 in a case where the first jackpot is selected, the second jackpot storage area 97 in a case where the second jackpot is selected, and the third jackpot storage area 98 in a case where the third jackpot is selected) on the basis of the result of the lottery process of S213. Thereafter, the main CPU 41 calculates an amount corresponding to 5% of betted credits on the basis of the betting operation information received in S211, adds the calculated number of credits to the read-out accumulation amount, and stores back the resultant accumulation amount in the RAM 43.

In S215, the main CPU 41 controls the upper image display panel 30 to display an image A. Here, the image A is an image in which, among the three fish that swim in the jackpot amount display screen 101 displayed in the upper image display panel 30, a fish corresponding to the jackpot, the accumulation amount of which has been added in S214 is given meal 107.

Here, the slot machine according to the third embodiment displays the jackpot amount display screen 101 shown in FIG. 1 in the upper image display panel 30 regardless whether a game is played by using the slot machine. Since the jackpot amount display screen 101 has been described with reference to FIGS. 1, 13 and 14, the description thereof is omitted here.

In S215, there is displayed an image A in which, among the three fish of first fish 103 to third fish 105 that swim in the jackpot amount display screen 101, a fish corresponding to the jackpot, the accumulation amount of which has been added in S214 (for example, the first fish 103 shown in FIG. 14) is given meal 107 and the fish eats the given meal 107. By displaying the image, the player is informed of the type of the jackpot that has been a target for the accumulation on the basis of the player's betting performed in this game.

Next, in S216, the CPU 41 determines whether the accumulation amount of the jackpot accumulated by the accumulation process of S214 is equal to or greater than a predetermined value (in the first embodiment, 1001 credits or 2001 credits). When it is determined that the accumulation amount is equal to or greater than a predetermined value (S216; YES), the CPU 41 controls the upper display panel 30 so as to display an image B (S217). Here, the image B is an image in which fish images of the first fish 103 to third fish 105 displayed in the jackpot amount display screen 101 are changed into further grown fish.

On the other hand, when it is determined that the accumulation amount is not equal to or greater than the predetermined value (S216; NO), the process proceeds to S218, and a lottery process in a base game is performed.

Next, a subsidiary process of the bonus game process of S222 that is performed by the slot machine according to the third embodiment will be described with reference to FIG. 19. FIG. 19 is a flowchart of a program for a bonus game process of the slot machine according to the third embodiment.

Here, processes of S231 to S234 are the same as those of the above-described S21 and S24 to S27 of the bonus game process (FIG. 12) according to the first embodiment of the invention, and accordingly, description thereof is omitted here.

At first, in S235, the main CPU 41 determines whether one among the first jackpot, the second jackpot, and the third jackpot is won on the basis of the lottery result of the bonus game in S241.

When it is determined that one jackpot is won (S235; YES), the accumulation amount of the won jackpot is updated to an initial value (S236). To be more specific, the main CPU 41 reads out the accumulation amount of credits accumulated in the first to third jackpot storage areas 96 to 98 corresponding to the type of jackpot that has been won (the first jackpot storage area 96 in a case where the first jackpot is won, the second jackpot storage area 97 in a case where the second jackpot is won, and the third jackpot storage area 98 in a case where the third jackpot is won) from the RAM 43. Thereafter, the read-out accumulation amount is changed to an initial value (for example, 2000 credits for the first jackpot, 1000 credits for the second jackpot, and 500 credits for the third jackpot) set in the corresponding jackpot in advance and the changed accumulation amount is stored back in the RAM 43.

In S237, the main CPU 41 controls the upper image display panel 30 to display an image C. Here, the image C is an image in which, among three fish of the first fish 103 to the third fish 105 displayed in the jackpot amount display screen 101 (FIG. 1), an image of the fish corresponding to the jackpot of which accumulation amount is changed to the initial value in S236 is changed to a small fish before being grown.

On the other hand, when it is determined that no jackpot is won (S235; NO), the corresponding bonus game jackpot updating process ends.

As described above, in a slot machine according to the third embodiment, a betting operation is performed on the basis of inserted coins, a lottery process of selecting a target jackpot among the first jackpot, the second jackpot, and the third jackpot in which credits corresponding to a predetermined rate for betted credits are accumulated is performed (S213) and predetermined credits are accumulated in the jackpot selected on the basis of the lottery result (S214), and accordingly, by providing a plurality of jackpots, increasing rates of credits accumulated in the jackpots can be changed by randomly changing a target jackpot for accumulation while the expectations of a player for the result of a game in relation with acquisition of the jackpots are increased. Accordingly, various games can be implemented in the slot machine that has progressive bonuses.

In addition, since the jackpot amount display screen 101 is displayed on the main display 5 and the accumulation amounts of credits currently accumulated in the jackpots can be indicated by the image types of three fishes of the first fish 103 to the third fish 105 that swim in the jackpot amount display screen 101, it becomes possible to increase the player's taste for the game.

The present invention is not limited to the above-described embodiments, and it is apparent that various altercations and modifications may be made therein without departing from the scope of the claimed invention.

For example, in the first and second embodiments, although the accumulation target lottery process (S13) for drawing of the type of jackpot, of which the accumulation amount is to be accumulated corresponding to a predetermined rate for betted credits is configured to be performed in the slot machine 1 side, the accumulation target lottery process may be configured to be performed in the server 2 side. In this case, it is preferable that only the betting information is transmitted from the slot machine 1 to the server 2 in the process of S14.

In the first to third embodiments, although credits of a predetermined rate are to be accumulated in one jackpot among the three types of jackpots that is determined by a lottery process, it may be configured that two or more jackpots are selected by a lottery process and credits of a predetermined rate may be accumulated in each selected jackpot.

In the first to third embodiments, although a bonus game in which four cards are selected by a player is used, a bonus game in which a spot for fishing a fish in a pond 102 (see FIG. 13) is selected may be used. In addition, when a jackpot is won in a lottery process of a bonus game, it is preferable that a representation process of lifting up a fish corresponding to the jackpot won from the selected spot is performed.

In the first to third embodiments, although the added accumulation amounts accumulated in the jackpots or the accumulation amounts are configured to be indirectly indicated by images of fish, values of the added accumulation amounts or the accumulation amounts may be indicated by specific numbers. Moreover, both the images of fish and numbers may be configured to be displayed.

In the first to third embodiments, although the added accumulation amounts or the accumulation amounts are configured to be indirectly indicated by changing the corresponding image types of fish among a small fish, a medium fish, and a large fish, the added accumulation amounts or the accumulation amounts, for example, may be indicated by background images, background colors, or motions of characters other than the above-described images of fish.

In the first embodiment, although the accumulation amount accumulated in the jackpots from the initial values are configured to be indirectly indicated by changing the types of fish images as characters, accumulation rates with respect to the initial values (for example, 150% in a case where the initial value of the jackpot is 1000 credits and the current accumulation amount is 1500 credits) may be configured to be indicated.

In the first to third embodiments, although an example in which a plurality of jackpots are used in a progressive bonus process performed by a slot machine is described, the invention may be used in a progressive bonus game performed in, for example, a poker game, a bingo game, or the like.

What is claimed is:

1. A game system comprising:
a plurality of gaming machines that is provided for each of players, each of the gaming machines receiving a bet from respective one of the players;
a display; and
a controller that is connected to the gaming machines and operates to:
store a part of the bet in a plurality of bonus pools when the bet is received;
control the display to display images corresponding to the bonus pool amounts stored in the bonus pools; and
pay out a bonus pool amount that is stored in one of the bonus pools when a predetermined condition is satisfied.

2. The game system according to claim 1, wherein the controller further operates to:
determine accumulation amounts that are accumulated from initial amounts of the bonus pool amounts stored in the respective bonus pools; and
controls the display to display each of the images in one of a plurality of types of images that are respectively related to the determined accumulation amounts.

3. The game system according to claim 2, wherein the controller further operates to:
determine the bonus pool amounts stored in the respective bonus pools; and
control the display to display each of the images in one of plurality of types of images that are respectively related to the determined bonus pool amounts.

4. The game system according to claim 1, wherein the images are character images.

5. The game system according to claim 1, wherein the display is provided to be visible to all of the players.

6. The game system according to claim 1, wherein the display displays the images in a manner that indirectly indicates the bonus pool amounts stored in the bonus pools.

7. A gaming machine comprising:
an operation unit that receives a bet from a player;
a display; and
a processor that operates to:
store a part of the bet in a plurality of bonus pools when the bet is received;
control the display to display images corresponding to the bonus pool amounts stored in the bonus pools; and
pay out a bonus pool amount that is stored in one of the bonus pools when a predetermined condition is satisfied.

8. The gaming machine according to claim 7, wherein the processor further operates to:
determine accumulation amounts that are accumulated from initial amounts of the bonus pool amounts stored in the respective bonus pools; and
controls the display to display each of the images in one of a plurality of types of images that are respectively related to the determined accumulation amounts.

9. The gaming machine according to claim 7, wherein the processor further operates to:
determine the bonus pool amounts stored in the respective bonus pools; and
control the display to display each of the images in one of plurality of types of images that are respectively related to the determined bonus pool amounts.

10. The gaming machine according to claim 7, wherein the images are character images.

11. The gaming machine according to claim 7, wherein the display displays the images in a manner that indirectly indicates the bonus pool amounts stored in the bonus pools.

12. A method for providing a game to a player, the method comprising:
receiving a bet from the player;
storing a part of the bet in a plurality of bonus pools when the bet is received;
displaying images corresponding to the bonus pool amounts stored in the bonus pools; and
paying out a bonus pool amount that is stored in one of the bonus pools when a predetermined condition is satisfied.

13. The method according to claim 12 further comprising:
determining accumulation amounts that are accumulated from initial amounts of the bonus pool amounts stored in the respective bonus pools; and
displaying each of the images in one of a plurality of types of images that are respectively related to the determined accumulation amounts.

14. The method according to claim 12 further comprising:
determining the bonus pool amounts stored in the respective bonus pools; and
displaying each of the images in one of plurality of types of images that are respectively related to the determined bonus pool amounts.

15. The method according to claim 12, wherein the images are character images.

16. The method according to claim 12, wherein the images are displayed in a manner that indirectly indicates the bonus pool amounts stored in the bonus pools.
